(19) United States
(12) Patent Application Publication
(10) Pub. No.: US 2023/0222420 A1
(43) Pub. Date: Jul. 13, 2023

(54) OPERATION SUPPORT DEVICE, OPERATION SUPPORT METHOD AND OPERATION SUPPORT PROGRAM

(71) Applicant: Nippon Telegraph and Telephone Corporation, Tokyo (JP)

(72) Inventors: Makoto Komiyama, Musashino-shi, Tokyo (JP); Akira Kataoka, Musashino-shi, Tokyo (JP); Masashi Tadokoro, Musashino-shi, Tokyo (JP); Hidetaka Koya, Musashino-shi, Tokyo (JP)

(21) Appl. No.: 17/924,260

(22) PCT Filed: May 15, 2020
(86) PCT No.: PCT/JP2020/019505

§ 371 Date: Nov. 9, 2022

(51) Int. Cl. G06Q 10/0633

(52) U.S. Cl. CPC G06Q 10/0633

(57) ABSTRACT

An acquisition unit (15a) acquires operation information of a user on the screen that the user operates. An identification unit (15b) identifies a progress state in a predetermined work flow, using the acquired operation information. A display control unit (15c) causes the work flow and the identified progress state to be displayed.

### TECHNICAL FIELD

The present invention relates to an operation support device, an operation support method and an operation support program.

### BACKGROUND ART

A work system tends to be designed complicated with many operation items for users with a high skill level because many users repeatedly use the work system unlike an EC site and the like for general consumers. However, there may be cases where not only a user with little work experience such as a new employee but a user with some work experience is required to operate an unfamiliar work system, being requested to do a plurality of kinds of work alone for the reason of decrease in working population or improvement of productivity. For such a user, there is known an annotation technology for displaying help information on a screen in order to provide support without changing an existing system (Non-Patent Literature 1).

### CITATION LIST

### Non-Patent Literature

Non-Patent Literature 1: “Input Assistant Tool BizFront/Annotation”, [online] NTT TechnoCross Corporation, [retrieved on Apr. 3, 2020], Internet <URL: https://www.ntt-tx.co.jp/products/bizfront-ant/>

### SUMMARY OF THE INVENTION

### Technical Problem

However, even if a procedure is displayed by the prior-art annotation technique, it is difficult for a user to intuitively forecast an operation on a screen with many operation items or a screen with the operation procedure which is complicated.

The present invention has been made in view of the above, and an object of the present invention is to enable a user who is unfamiliar with operation to easily forecast operation of a system screen.

### Means for Solving the Problem

In order to solve the problem described above and achieve the object, an operation support device according to the present invention includes: an acquisition unit acquiring operation information of a user on a screen that the user operates; an identification unit identifying a progress state in a predetermined work flow, using the acquired operation information; and a display control unit causing the work flow and the identified progress state to be displayed to the user.

### Effects of the Invention

According to the present invention, it easily becomes possible for a user who is unfamiliar with operation to forecast operation on a system screen.

### BRIEF DESCRIPTION OF DRAWINGS

FIG. 1 is a schematic diagram illustrating a schematic configuration of an operation support device of the present embodiment.

FIG. 2 is a diagram for illustrating a process of an identification unit and a display control unit.

FIG. 3 is a diagram for illustrating a process of the identification unit and the display control unit.

FIG. 4 is a diagram for illustrating a process of the identification unit and the display control unit.

FIG. 5 is a diagram for illustrating a process of the identification unit and the display control unit.

FIG. 6 is a diagram for illustrating a process of the identification unit and the display control unit.

FIG. 7 is a diagram for illustrating a process of the identification unit and the display control unit.

FIG. 8 is a diagram for illustrating a process of the identification unit and the display control unit.

FIG. 9 is a diagram for illustrating a process of the identification unit and the display control unit.

FIG. 10 is a diagram for illustrating a process of the identification unit and the display control unit.

FIG. 11 is a diagram for illustrating a process of the identification unit and the display control unit.

[FIG. 12 is a diagram for illustrating a process of the identification unit and the display control unit.

FIG. 13 is a diagram for illustrating a process of the identification unit and the display control unit.

FIG. 14 is a diagram for illustrating a process of an extension unit.

FIG. 15 is a diagram for illustrating a process of the extension unit.

FIG. 16 is a diagram for illustrating a process of the extension unit.

FIG. 17 is a flowchart showing an operation support process procedure.

FIG. 18 is a diagram showing an example of a computer to execute an operation support program.

### DESCRIPTION OF EMBODIMENT

An embodiment of the present invention will be described below in detail with reference to drawings. Note that the present invention is not limited by the embodiment. In description on the drawings, the same units are shown being given the same reference numeral.

### Configuration of Operation Support Device

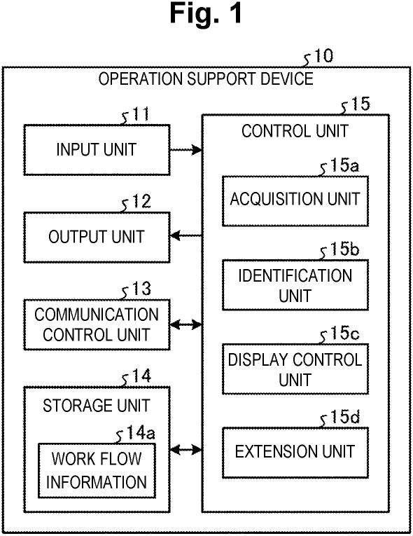

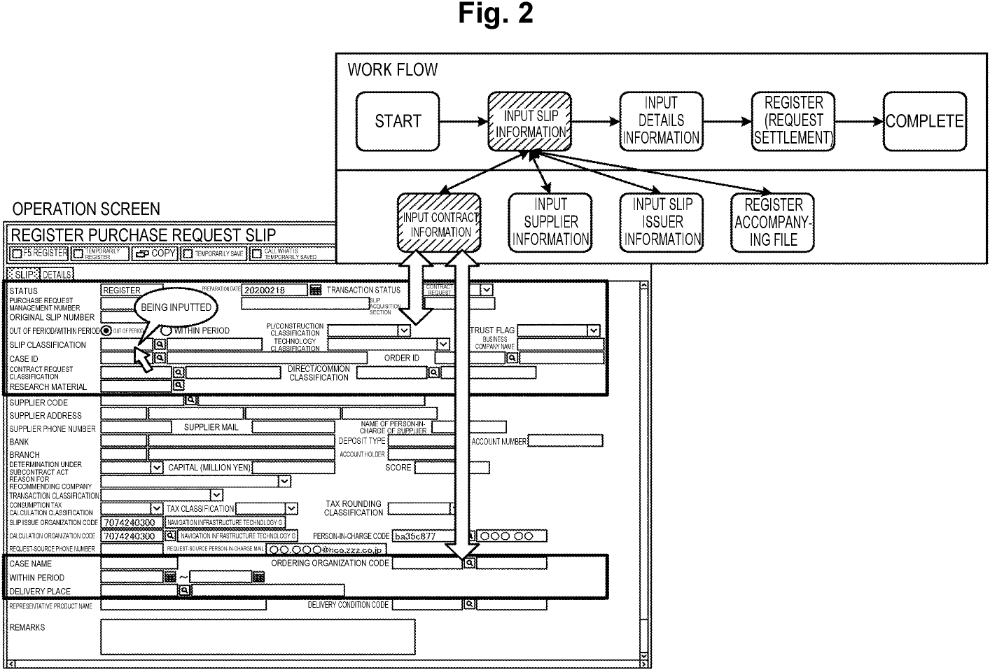

FIG. 1 is a schematic diagram illustrating a schematic configuration of an operation support device of the present embodiment. As illustrated in FIG. 1, an operation support device 10 of the present embodiment is realized by a general-purpose computer such as a personal computer and is provided with an input unit 11, an output unit 12, a communication control unit 13, a storage unit 14 and a control unit 15.

The input unit 11 is realized by input devices such as a keyboard and a mouse, and the input unit 11 inputs various kinds of instruction information such as an instruction to start a process and the like, to the control unit 15, according to an input operation by an operator. The input unit 11 may be realized by a sensor that a terminal such as a camera, a GPS or a microphone is provided with. The output unit 12 is realized by a display device such as a liquid crystal display, a printing device such as a printer, and the like. For example, a result of an operation support process to be described later is displayed on the output unit 12.

The communication control unit 13 is realized by an NIC (network interface card) or the like and controls communication between external devices and the control unit 15 via a telecommunication line such as a LAN (local area network) and the Internet. For example, the communication control unit 13 control communication between a terminal that a user operates, a management device or the like that manages various kinds of information related to work such as a work flow and the like, and the control unit 15.

The storage unit 14 is realized by a semiconductor memory element such as a RAM (random access memory) and a flash memory, or a storage device such as a hard disk and an optical disk. In the storage unit 14, a processing program that causes the operation support device 10 to operate, data used during execution of the processing program and the like are stored in advance or temporarily stored each time a process is performed. Note that the storage unit 14 may be configured to communicate with the control unit 15 via the communication control unit 13.

In the present embodiment, the storage unit 14 stores work flow information 14a and the like. The work flow information 14a is information indicating a work flow for work on a terminal of a work system that the user operates, and is displayed, for example, on the output unit 12 by the operation support process to be described later.

The work flow information 14a is read from the terminal where the work flow information 14a is stored or acquired from the management device or the like, and stored into the storage unit 14 in advance prior to the operation support process to be described later. Note that the terminal that the user operates may be implemented on the same hardware as the operation support device 10.

The work flow information 14a is not limited to the case of being stored in the storage unit 14 but may be collected at the time of the operation support process to be described later being executed. In that case, for example, an acquisition unit 15a to be described later may collect the work flow information 14a prior to a process by an identification unit 15b.

Returning to the description of FIG. 1, the control unit 15 is realized using a CPU (central processing unit) or the like, and executes the processing program stored in the memory. Thereby, the control unit 15 functions as the acquisition unit 15a, the identification unit 15b, a display control unit 15c and an extension unit 15d as illustrated in FIG. 1. Note that each of or a part of these functional units may be implemented on different hardware. The control unit 15 may be provided with other functional units.

The acquisition unit 15a acquires operation information of the user on the screen that the user operates. Specifically, the acquisition unit 15a acquires start-up states of applications on the OS, information about an operation target application inputted by the user, and the like on the terminal that the user operates, via the input unit 11 or the communication control unit 13. For example, the acquisition unit 15a acquires information specified by the identification unit 15b to be described later.

Here, the operation information is one or more among information about an application started up on the terminal, information about terminal control and information that can be acquired from a sensor that the terminal is provided with. The information about terminal control is, for example, information about which application has been started up. The information about an application started up on the terminal is, for example, a user operation, data to be displayed, the URL of an opened page and the like. The information that can be acquired from a sensor that the terminal is provided with is, for example, an image, GPS information, acceleration, voice and the like.

The identification unit 15b identifies a progress state in a predetermined work flow, using the acquired operation information.

Specifically, first, the identification unit 15b acquires work flow information 14a corresponding to the user’s work. If a work flow to be initially displayed is not specified in advance, the identification unit 15b specifies information required to identify a display target work flow, such as start-up states of applications on the OS and information about an operation target application inputted by the user, to the acquisition unit 15a based on the work flow information 14a. The identification unit 15b determines the display target work flow based on the acquired information.

Next, the identification unit 15b specifies operation information required to identify a progress state, to the acquisition unit 15a based on the work flow information. Then, the identification unit 15b determines the progress state of the work based on the acquired operation information.

The display control unit 15c causes the work flow and the identified progress state to be displayed to the user. For example, the display control unit 15c displays the determined work flow and reflects the identified progress state on the work flow. The display control unit 15c updates displayed content if necessary.

In other words, the display control unit 15c outputs a work flow on which a progress state of the user’s work is reflected, which is a result of the operation support process, to the output unit 12. Note that, the output destination of the operation support process result by the display control unit 15c is not limited to the output unit 12. For example, the operation support process result may be outputted to the screen that the user operates. In that case, for example, the operation support process result may be outputted by dividing the screen or outputted in a manner that parts are overlapped.

Here, FIGS. 2 to 13 are diagrams for illustrating the process of the identification unit 15b and the display control unit 15c. Specifically, first, the operation support device 10 displays a work flow for the user’s work and displays an operation position on the work flow so that the user can visually confirm it, based on operation information of the user on the operation screen as shown in FIG. 2. In the example shown in FIG. 2, it is detected that the user is inputting for an operation item “Slip Classification”, and display is shown so that it is seen that the input corresponds to “Input Contract Information” under “Input Slip Information” on the work flow. Display of the work flow in this state is continued until input for an input item on the operation screen corresponding to “Input Slip Information” shown being surrounded by a thick frame in FIG. 2 is completed.

Note that, in the operation support device 10, it is possible to flexibly set and display dependencies among flows such as parallel, parent and child and order by defining the work flow information 14a in advance as illustrated in FIG. 2.

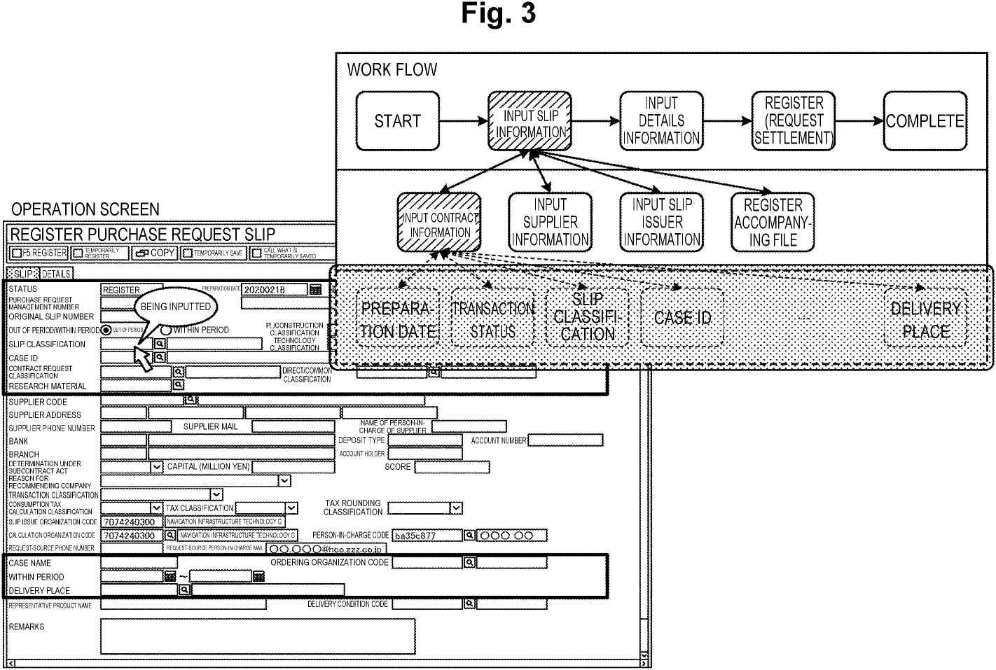

The identification unit 15b is capable of switching between display and non-display of a specified part of the work flow. For example, in the example shown in FIG. 3, display/non-display of a work flow subordinate to “Input Contract Information” on the work flow can be switched. For example, switching may be performed when the user clicks a relevant position. For example, it becomes possible to switch to display when desiring to know a UI to be specifically inputted and switch to non-display when desiring to confirm the work flow with rough granularity.

The identification unit 15b can further identify a completed part of the work flow. For example, when all the subordinate work flow has been completed, the identification unit 15b determines that the work flow has been completed. Similarly, it is possible to identify a part for which the work has not been completed. For example, when input has been started once, but input for all the operation items has not been completed, the identification unit 15b determines that the work flow is uncompleted. The identification unit 15b can do it because it grasps the work flow and the progress state. For example, when the next operation item on the work flow is transitioned to, the identification unit 15b can determine completed/uncompleted.

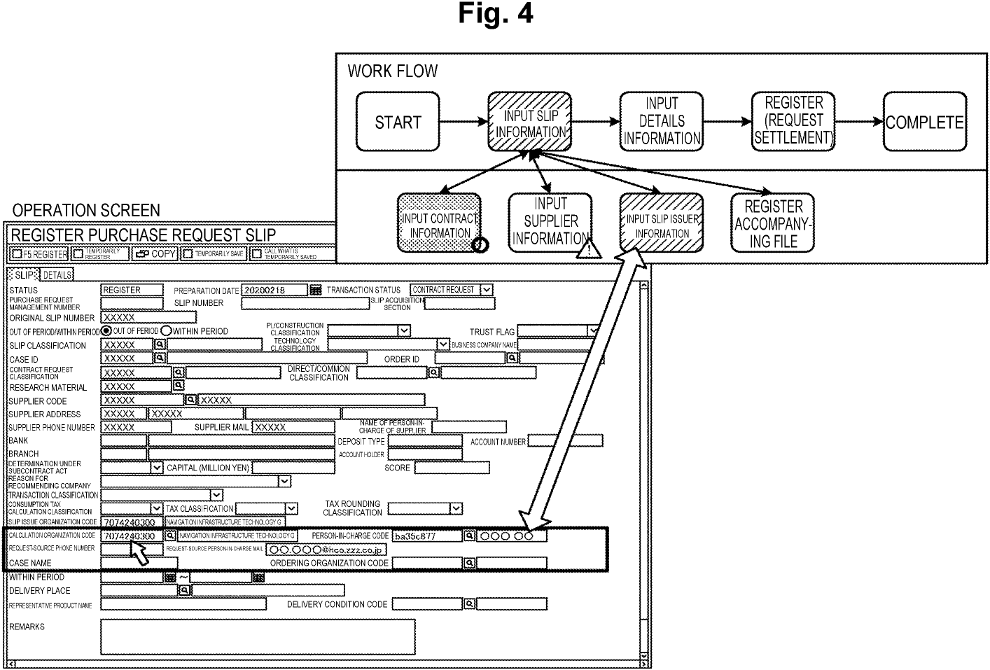

In the example shown in FIG. 4, by giving a circle when an operation corresponding to “Input Slip Issuer Information” on the work flow is being performed, it is shown that input for “Input Contract Information” has been completed. Further, by giving an exclamation mark at this time, it is shown that input for “Input Supplier Information” has not been completed.

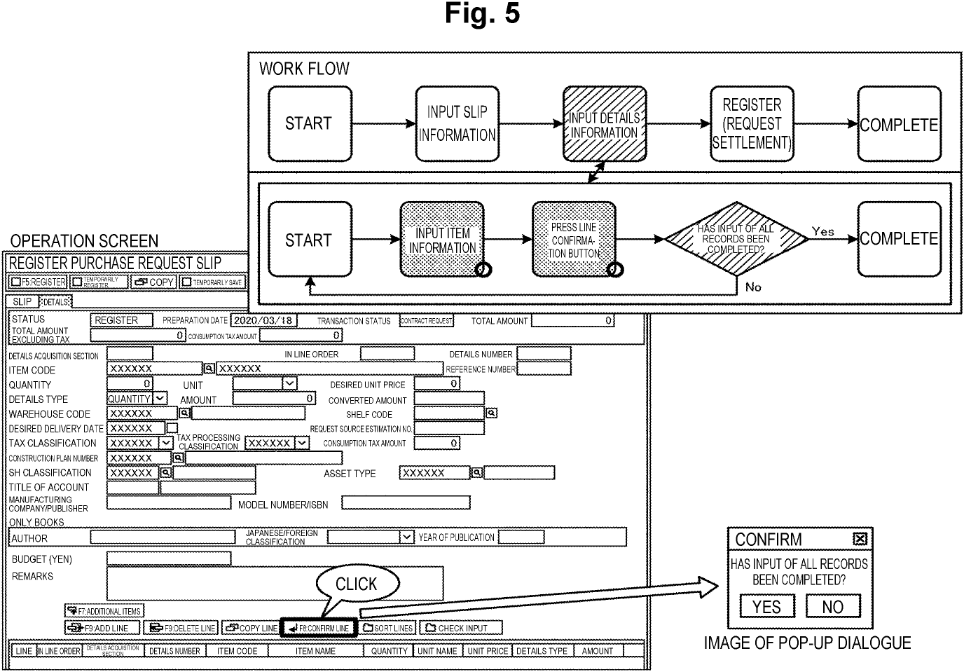

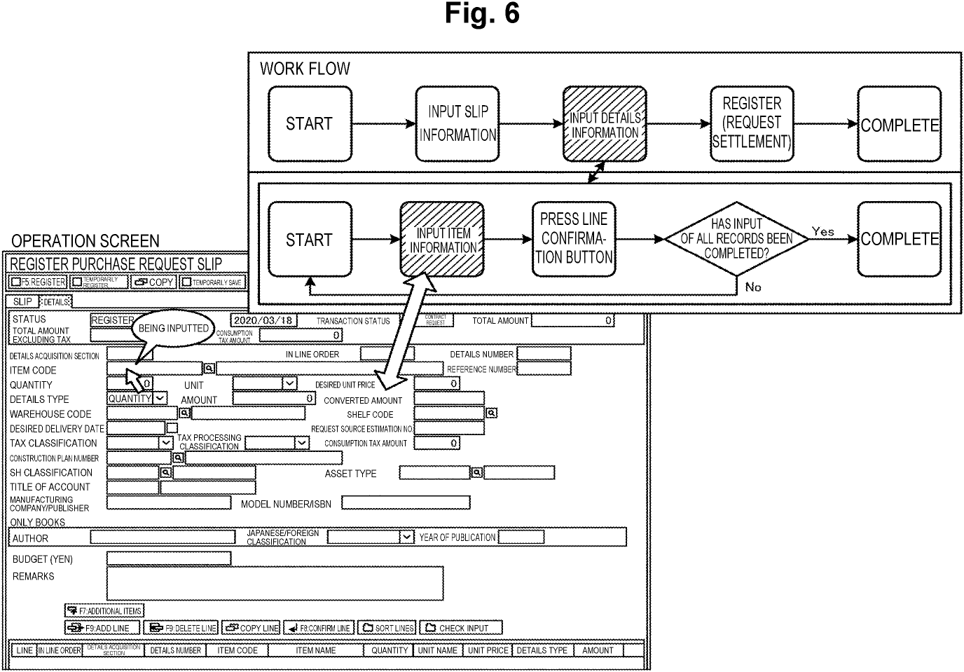

The identification unit 15b may further accept input of information about a progress state by the user via the display control unit 15c. In the example shown in FIG. 5, when it is not possible to determine being completed only by operation information of the user for such an operation item that records are repeatedly inputted, a pop-up dialog requesting input of completed/uncompleted is presented to accept an input by the user. Or alternatively, the identification unit 15b may determine being completed by another operation screen being transitioned to, or a menu of “Complete Current Work Flow” may be provided as a menu of the application.

Note that, in the operation support device 10, even if the operation screen transitions, management of the progress state is continued, and display of the work flow is continued. In the example shown in FIG. 6, even when the “Slip” operation screen transitions to the “Details” operation screen, display of the work flow is similarly continued.

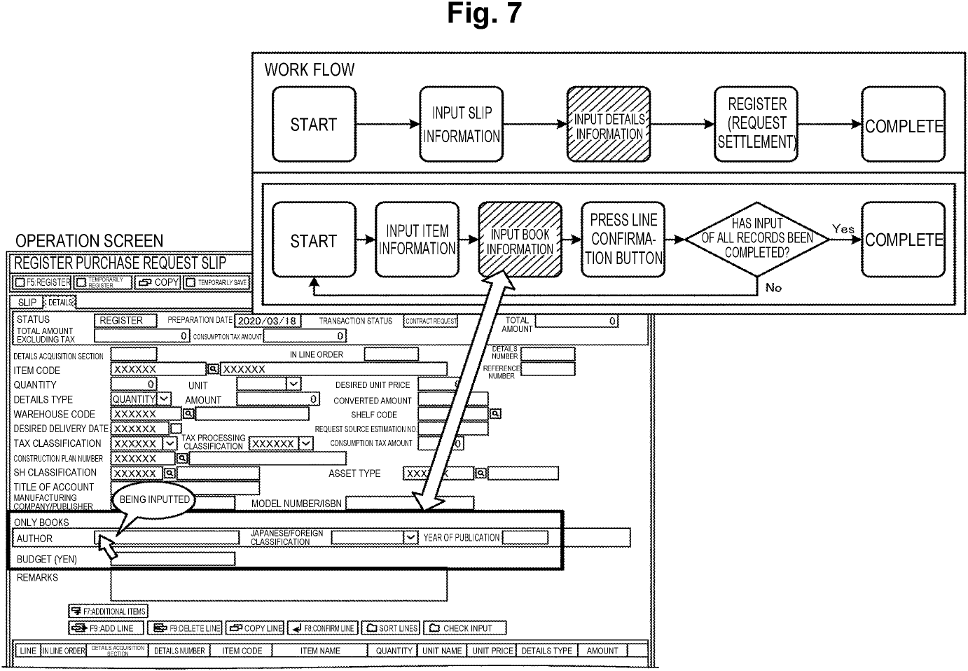

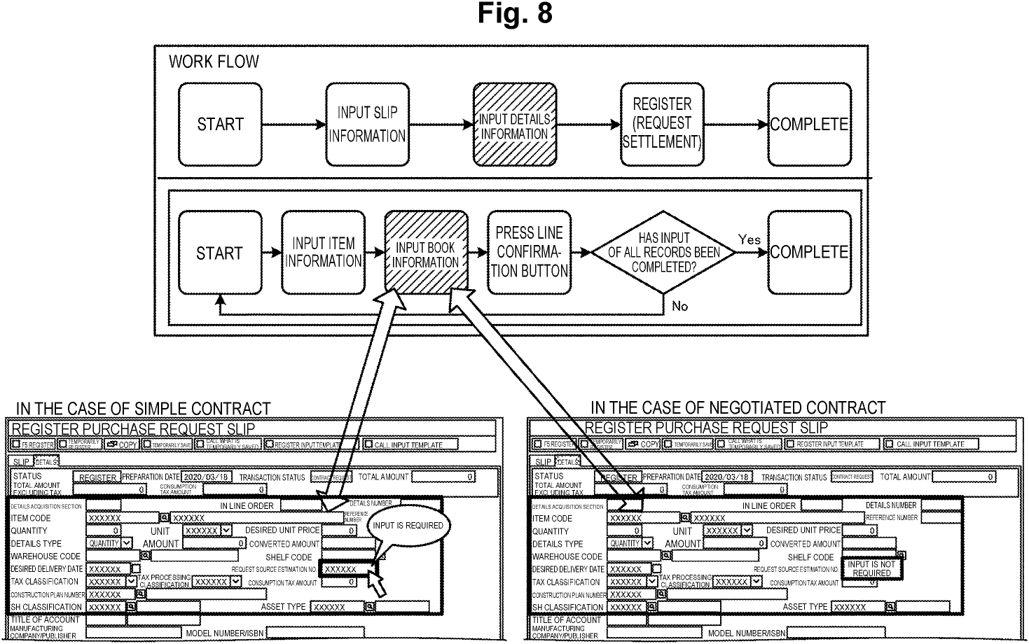

Further, in the operation support device 10, even if operation screens are the same, different work flows are displayed when works are different. In the example shown in FIG. 7, it is shown that the operation item “Author” for which input is being performed corresponds to “Input Book Information” on the work flow. In comparison, in the example shown in FIG. 6, though the operation screen is the same as the example in FIG. 7, different display is shown, and the operation item “Product Name Code” for which input is being performed corresponds to “Input Item Information” on the work flow.

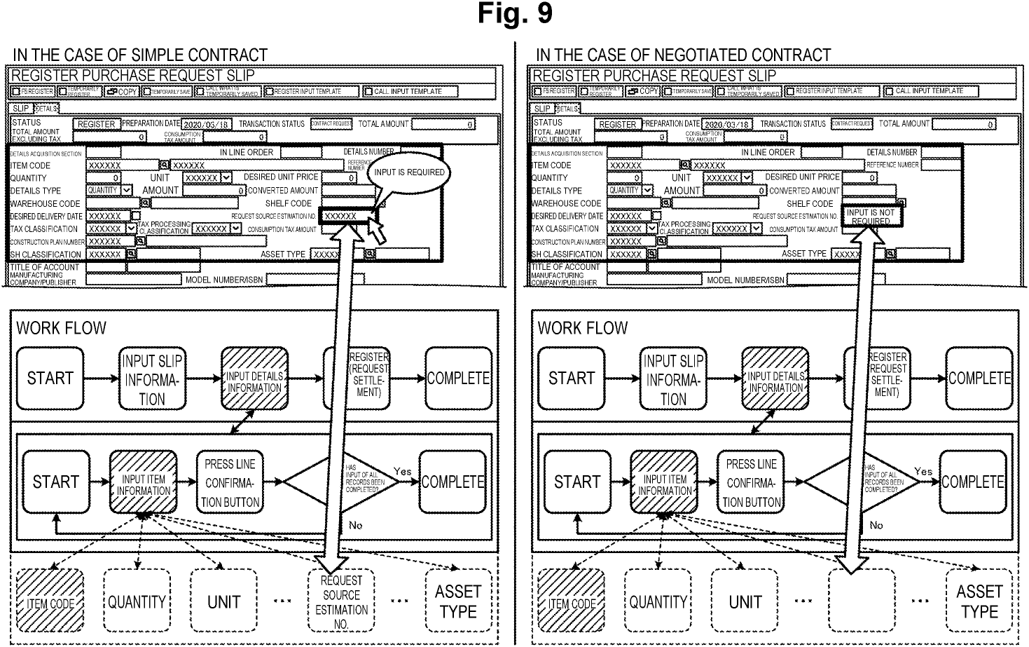

Similarly, even if operation screens and work systems are the same, different work flows are displayed when subordinate detailed work flows are different. In the example shown in FIG. 8, between the simple contract and the voluntary contract, “Input Item Information” on the work flow is the same, but subordinate work flows are different in a UI for input. For example, they are different in “required/not required” for input for “Request Source Estimation No.” In this case, different work flows can be displayed as shown in FIG. 9.

The identification unit 15b may further identify support information corresponding to an identified progress state. For example, in the operation support device 10, text data showing information referred to by a user operation or support information such as the URL of a site on which the information referred to is presented are stored in the storage unit 14 in association with a progress state in advance. The identification unit 15b identifies support information corresponding to progress information. The identified support information is presented, for example, via the display control unit 15c.

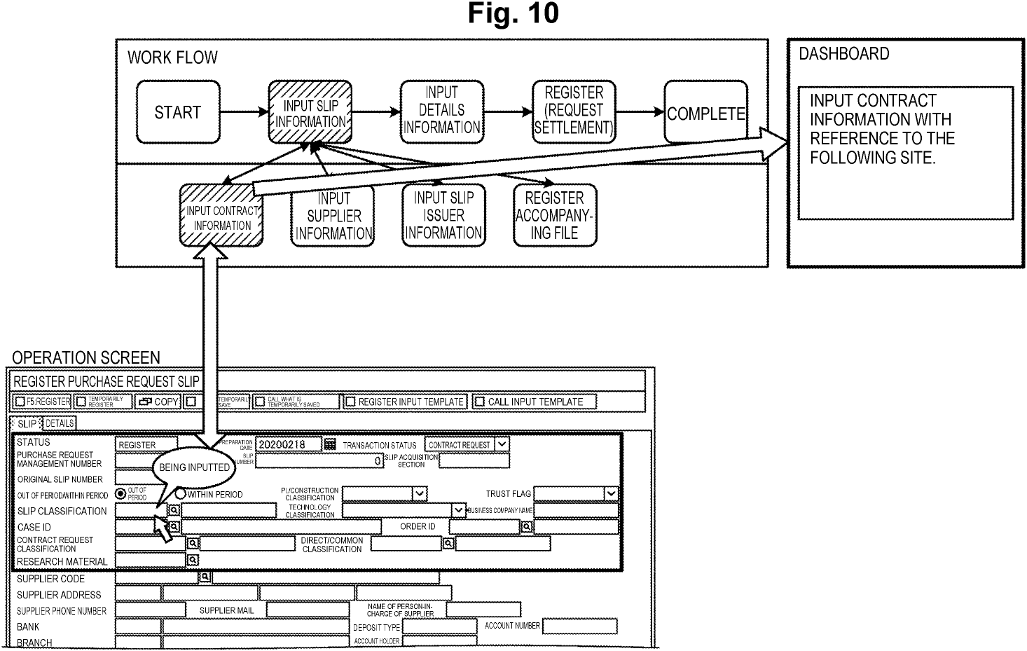

In the example shown in FIG. 10, support information corresponding to “Input Contract Information” on the work flow is identified when input is performing for the operation item “Slip Classification”, and the support information is presented in a dashboard.

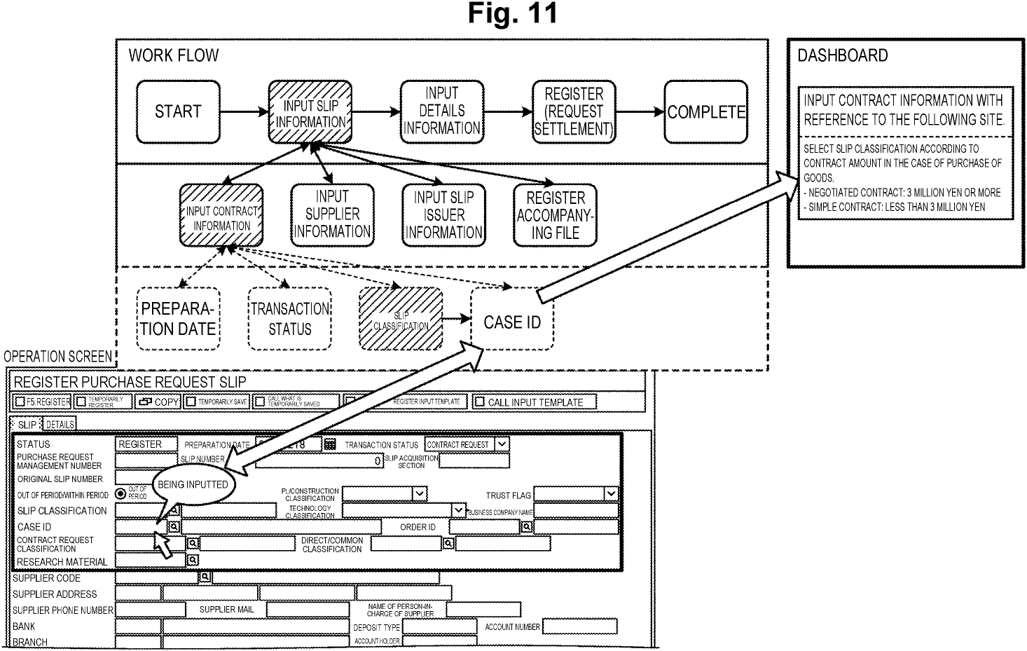

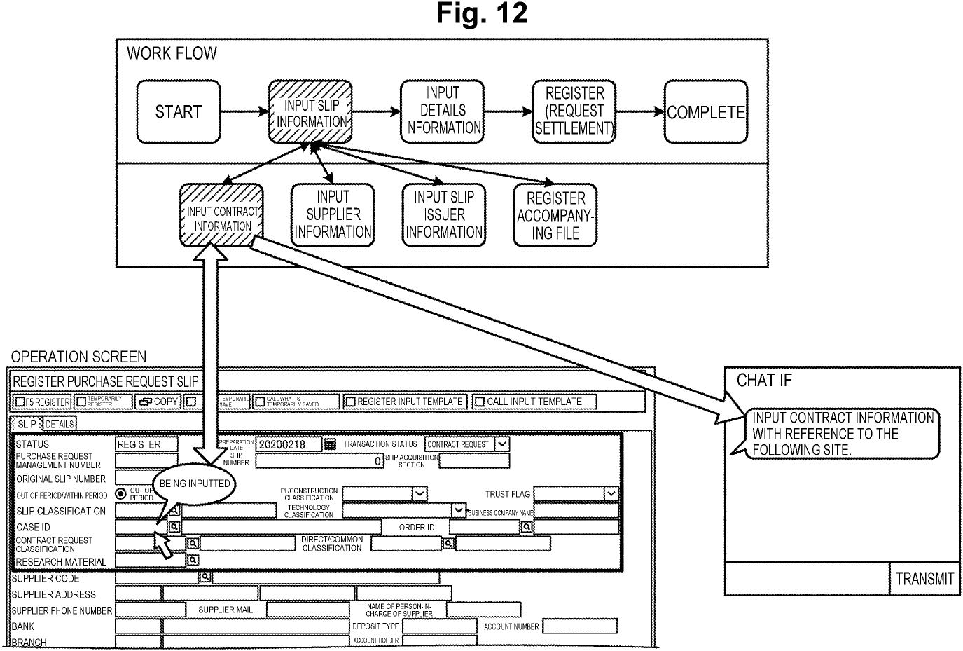

Further, in the example shown in FIG. 11, support information corresponding to “Slip Classification” on the work flow subordinate to “Input Contract Information” on the work flow is identified and presented in a dashboard when input is performing for the operation item “Slip Classification”.

The support information may be uttered via an external chatbot. In the example shown in FIG. 12, support information corresponding to “Input Contract Information” on the work flow is identified and presented via chatbot when input is performing for the operation item “Slip Classification”.

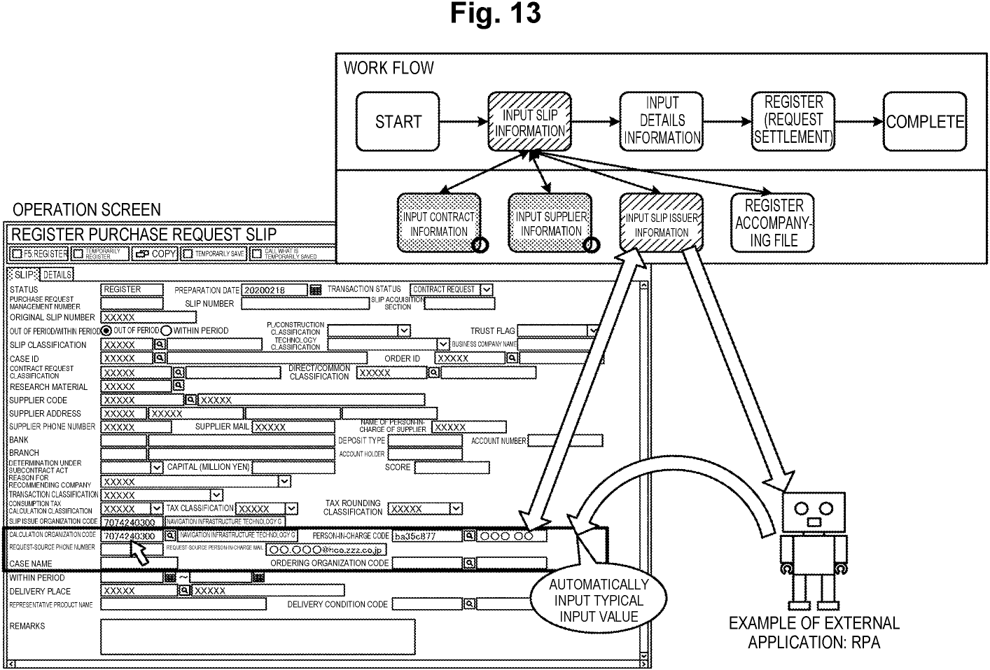

The identification unit 15b may distribute an identified progress state to other applications or other terminals. In the example shown in FIG. 13, a progress state that input for “Input Supplier Information” on the work flow has been completed is transmitted to an external application such as RPA (Robotic Process Automation), and automatic input of a typical input value is executed for the next-stage work “Input Slip Issuer Information”.

Returning to the description of FIG. 1, the control unit 15 may be provided with an extension unit 15d. The extension unit 15d causes an extended UI to be displayed on the screen that the user operates, according to an identified progress state.

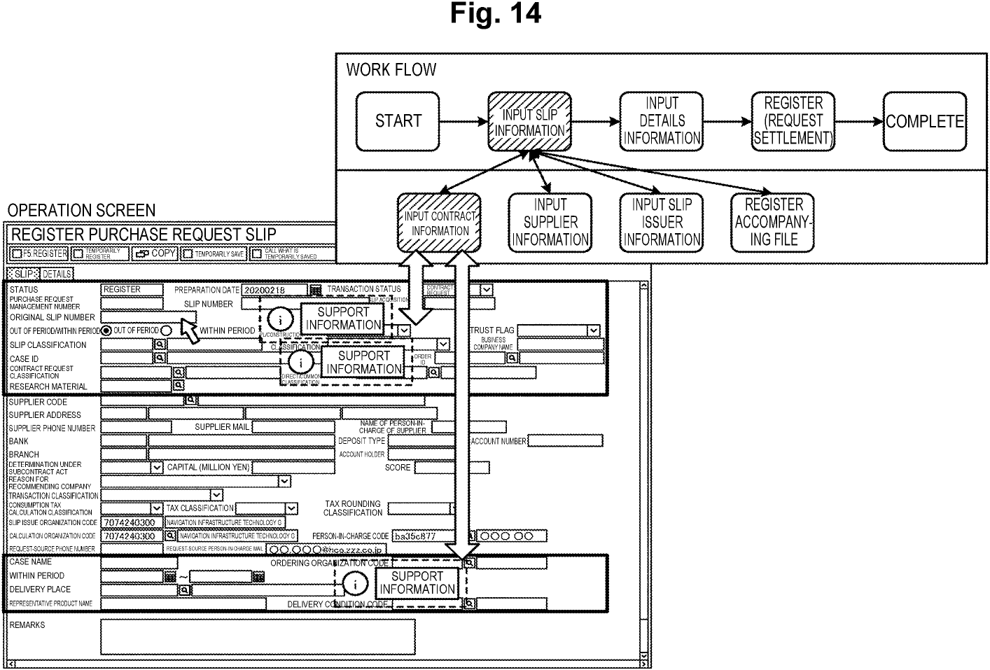

Here, FIGS. 14 to 16 are diagrams for describing a process of the extension unit 15d. For example, the extension unit 15d causes an extended UI showing support information (annotation) corresponding to a progress state to be displayed on the screen of the terminal that the user operates. In the example shown in FIG. 14, support information corresponding to “Input Contract Information” on the work flow is displayed on the operation screen.

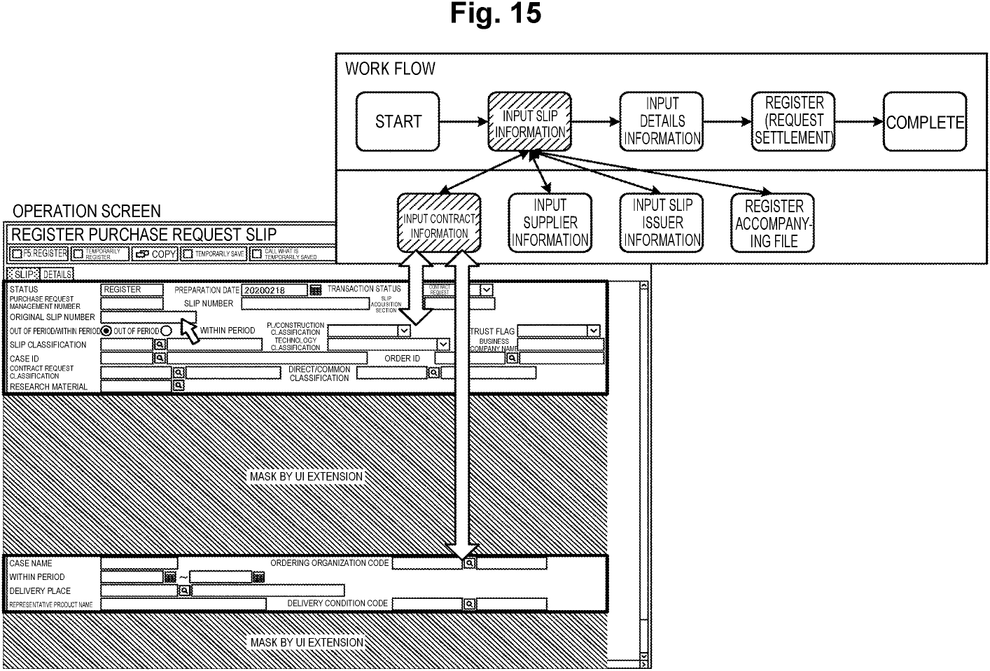

Further, the extension unit 15d causes extended UIs for masking parts other than an operation target to be displayed according to a progress state. In the example shown in FIG. 15, operation items other than operation items corresponding to “Input Contract Information” on the work flow are masked by extended UIs.

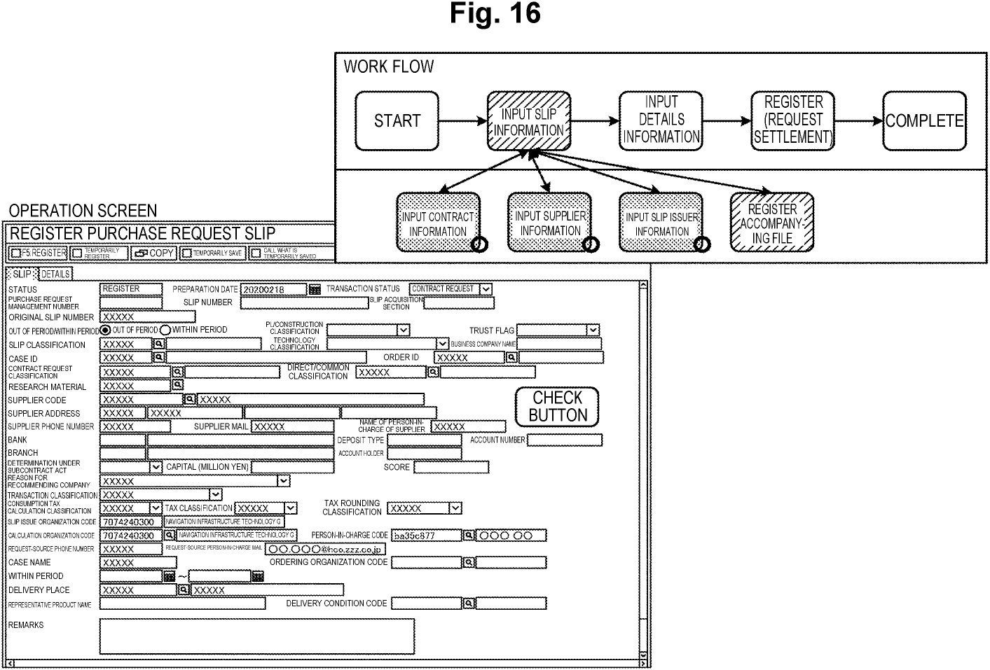

Further, the extension unit 15d causes a check button for checking inputted content as an extended UI according to a progress state. In the example shown in FIG. 16, when input for “Input Slip Issuer Information” on the work flow is completed, an extended UI of a check button for checking whether inputted content follows rules is displayed.

Thus, it becomes possible for the operation support device 10 to give more direct operation support to the user or the operation screen by using extended UIs.

### Operation Support Process

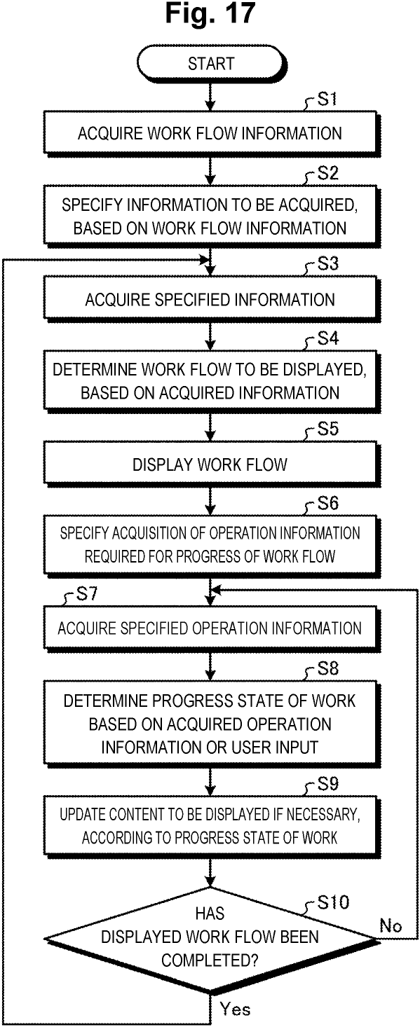

Next, the operation support process by the operation support device 10 according to the present embodiment will be described with reference to FIG. 17. FIG. 17 is a flowchart showing an operation support process procedure. The flowchart in FIG. 17 is started, for example, at a timing of the user performing an operation input to give a start instruction.

Note that, a start condition may be, for example, that a particular screen is displayed, that the work flow information 14a is read, that a work flow is selected by the user, using a dedicated GUI, that the user moves to a particular place using a GPS sensor provided for the terminal, or a start-up state of an application.

First, the identification unit 15b acquires work flow information 14a corresponding to the user’s work (step S1). Further, the identification unit 15b specifies information required to identify a work flow to be displayed, such as start-up states of applications on the OS and information about an operation target application inputted by the user, to the acquisition unit 15a based on the work flow information 14a (step S2). The acquisition unit 15a acquires the specified information (step S3).

The identification unit 15b determines the display target work flow based on the acquired information (step S4). The display control unit 15c displays the determined work flow (step S5).

Further, the identification unit 15b specifies operation information required to identify a progress state, to the acquisition unit 15a based on the work flow information (step S6). The acquisition unit 15a acquires the specified operation information of the user (step S7).

The identification unit 15b determines the progress state of the work based on the acquired operation information or input information by the user if input from the user has been accepted (step S8). The display control unit 15c reflects the identified progress state on the work flow. For example, display content on the output unit 12 is updated if necessary (step S9).

The identification unit 15b determines whether the displayed work flow has been completed or not; returns the process to step S7 if the work flow has not been completed (step S10: No); and returns the process to step S3 if the work flow has been completed (step S10: Yes). Thereby, the operation support process procedure ends.

As described above, in the operation support device 10 of the present embodiment, the acquisition unit 15a acquires operation information of the user on the screen that the user operates. The identification unit 15b identifies a progress state in a predetermined work flow, using the acquired operation information. The display control unit 15c causes the work flow and the identified progress state to be displayed to the user.

Thereby, the operation support device 10 enables the user who is unfamiliar with operation to easily forecast operation on a system screen.

Further, the identification unit 15b is capable of switching between display and non-display of a specified part of the work flow. This makes it possible for the user to more easily forecast operation and grasp a progress state.

The identification unit 15b further identifies a part of the work flow that has been completed. Thereby, it becomes easier for the user to forecast operation. Further, it becomes possible to, when there is an uncompleted operation, notify the user thereof. This makes it possible for the user to more easily forecast operation and grasp a progress state.

The identification unit 15b further accepts input of information about a progress state by the user via the display control unit 15c. Thus, it becomes possible for the operation support device 10 to grasp a progress state more accurately.

The identification unit 15b further identifies support information corresponding to the identified progress state. Thereby, convenience for the user is enhanced.

The identification unit 15b transmits the identified progress state to other applications and other terminals. This makes it possible to support operation by the user more effectively.

### Program

It is also possible to create a program in which the process executed by the operation support device 10 according to the above embodiment is written in a computer-executable language. As one embodiment, the operation support device 10 can be implemented by causing an operation support program to execute the above operation support process to be installed in a desired computer as package software or online software. For example, by causing an information processing device to execute the above operation support program, it is possible to cause the information processing device to function as the operation support device 10. As the information processing device stated here, a desktop type or notebook type personal computer is included. In addition, mobile communication terminals such as a smartphone, a mobile phone and a PHS (personal handy-phone system), and slate terminals such as a PDA (personal digital assistant) are included in the category of the information processing device. Further, the functions of the operation support device 10 may be implemented in a cloud server.

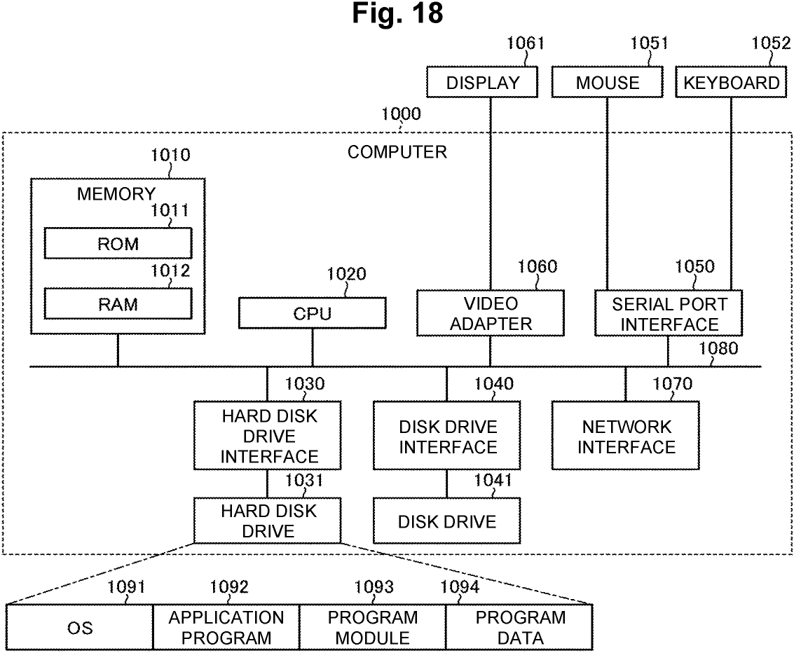

FIG. 18 is a diagram showing an example of the computer to execute the operation support program. A computer 1000 has, for example, a memory 1010, a CPU 1020, a hard disk drive interface 1030, a disk drive interface 1040, a serial port interface 1050, a video adapter 1060 and a network interface 1070. These units are connected via a bus 1080.

The memory 1010 includes a ROM (read-only memory) 1011 and a RAM 1012. The ROM 1011 stores, for example a boot program such as BIOS (basic input/output system). The hard disk drive interface 1030 is connected to a hard disk drive 1031. The disk drive interface 1040 is connected to a disk drive 1041. For example, a removable storage medium such as a magnetic disk or an optical disk is inserted into the disk drive 1041. To the serial port interface 1050, for example, a mouse 1051 and a keyboard 1052 are connected. To the video adapter 1060, for example, a display 1061 is connected.

Here, the hard disk drive 1031 stores, for example, an OS 1091, an application program 1092, a program module 1093 and program data 1094. Each piece of information described in the above embodiment is stored, for example, in the hard disk drive 1031 or the memory 1010.

Further, the operation support program is stored in the hard disk drive 1031, for example, as a program module 1093 in which commands to be executed by the computer 1000 are written. Specifically, the program module 1093 in which each process to be executed by the operation support device 10 described in the above embodiment is written is stored in the hard disk drive 1031.

Further, data to be used for information processing by the operation support program is stored, for example, in the hard disk drive 1031 as the program data 1094. Then, the CPU 1020 reads the program module 1093 and the program data 1094 stored in the hard disk drive 1031 to the RAM 1012 as necessary and executes each procedure described above.

Note that the program module 1093 and the program data 1094 related to the operation support program may not only be stored in the hard disk drive 1031 but also may be stored, for example, in a removable storage medium and read out by the CPU 1020 via the disk drive 1041 or the like. Or alternatively, the program module 1093 and the program data 1094 related to the operation support program may be stored in another computer connected via a network such as a LAN and a WAN (wide area network) and read out by the CPU 1020 via the network interface 1070.

The embodiment to which the invention made by the present inventor is applied has been described above. However, the present invention is not limited to the description and the drawings forming a part of the disclosure of the present invention by the present embodiment. In other words, all of other embodiments, implementation examples, operation techniques and the like made by those skilled in the art based on the present embodiment are included in the scope of the present invention.

Reference Signs List

| | |
|---|---|
| 10 | Operation support device |
| 11 | Input unit |
| 12 | Output unit |
| 13 | Communication control unit |
| 14 | Storage unit |
| 14 a | Work flow information |
| 15 | Control unit |
| 15 a | Acquisition unit |
| 15 b | Identification unit |
| 15 c | Display control unit |
| 15 d | Extension unit |

1. An operation support device, the operation support device comprising one or more processors configured to:
acquire operation information of a user on a screen that the user operates;
identify a progress state in a predetermined work flow, using the acquired operation information; and
cause the work flow and the identified progress state to be displayed to the user.

2. The operation support device according to claim 1, wherein the operation information is one or more among information about an application started up on a terminal, information about terminal control, and information that can be acquired from a sensor that the terminal is provided with.

3. The operation support device according to claim 1, wherein the one or more processors are configured to switch between display and non-display of a specified part of the work flow.

4. The operation support device according to claim 1, wherein the one or more processors are configured to identify a completed part of the work flow or support information corresponding to the identified progress state.

5. The operation support device according to claim 1, wherein the one or more processors are configured to accept input of information about the progress state by the user via the display control unit.

6. The operation support device according to claim 1, wherein the one or more processors are configured to transmit the identified progress state to other applications.

7. An operation support method executed by an operation support device, the method comprising:
acquiring operation information of a user on a screen that the user operates;
identifying a progress state in a predetermined work flow, using the acquired operation information; and
causing the work flow and the identified progress state to be displayed to the user.

8. An operation support program for causing a computer to execute:
acquiring operation information of a user on a screen that the user operates;
identifying a progress state in a predetermined work flow, using the acquired operation information; and
causing the work flow and the identified progress state to be displayed to the user.

9. The operation support method according to claim 7, wherein the operation information is one or more among information about an application started up on a terminal, information about terminal control, and information that can be acquired from a sensor that the terminal is provided with.

10. The operation support method according to claim 7, comprising switching between display and non-display of a specified part of the work flow.

11. The operation support method according to claim 7, comprising identifying a completed part of the work flow or support information corresponding to the identified progress state.

12. The operation support method according to claim 7, comprising accepting input of information about the progress state by the user via a display control unit.

13. The operation support method according to claim 7, comprising transmitting the identified progress state to other applications.

14. The operation support program according to claim 8, wherein the operation information is one or more among information about an application started up on a terminal, information about terminal control, and information that can be acquired from a sensor that the terminal is provided with.

15. The operation support program according to claim 8, comprising switching between display and non-display of a specified part of the work flow.

16. The operation support program according to claim 8, comprising identifying a completed part of the work flow or support information corresponding to the identified progress state.

17. The operation support program according to claim 8, comprising accepting input of information about the progress state by the user via a display control unit.
